(19) United States
(12) Patent Application Publication
(10) Pub. No.: US 2008/0140345 A1
(43) Pub. Date: Jun. 12, 2008

(54) STATISTICAL SUMMARIZATION OF EVENT DATA

(75) Inventors: Mark S. Ramsey, Kihei, HI (US); David A. Selby, Nr Fareham (GB); Stephen J. Todd, Hants (GB)

Correspondence Address: HOFFMAN, WARNICK & D'ALESSANDRO LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/567,905

(22) Filed: Dec. 7, 2006

(51) Int. Cl. G06F 17/18

(52) U.S. Cl. 702/179

(57) ABSTRACT

A system, method and program product for processing data events. A system is provided that includes a system for processing a set E of data event values Eᵢ, comprising: a system for selecting a function F(D); a system for estimating a value of X such that the sum of F(X−Eᵢ) for all data event values Eᵢ in the set E is zero, wherein the value X provides a general statistical property of the set of data event values E; and an analysis system that analyzes the general statistical property.

### FIELD OF THE INVENTION

The invention relates generally to analyzing event data, and more particularly to a system and method of providing one or more functions for providing a statistical summarization of event data.

### BACKGROUND OF THE INVENTION

There exist numerous applications in which analysis of event data may be required. For example, data events may be collected in a financial setting to identify potentially fraudulent activity, in a network setting to track network usage, in a business setting to identify business opportunities or problems, etc. Established practices in statistical analysis of data exist for processing and analyzing data events. Much of this has been based around two concepts for “typical” data, the mean and the median. Slightly more extensive analysis has also considered the spread of data around this typical point; that is at least partly captured by the standard deviation (used in conjunction with mean) and percentile values (used in conjunction with median).

There are problems with both the mean and median based methods—both from the mathematical behavior and their match to ‘common sense’ analysis. For example, in the mean/standard deviation approach, there is often too much dependency on outliers, although there are (somewhat arbitrary) techniques for ignoring them. Furthermore, computations are somewhat difficult when dealing with non-center data points. Additionally, assumptions must be made about a Gaussian distribution that may not be appropriate for all conditions.

In the median/percentiles approach, there may be too much dependency on data that is just to one side of the median value. This means that median calculations are often fairly unstable depending on the exact samples taken. Like the mean/standard deviation approach, computational costs may be expensive.

In traditional statistics, the above approaches are utilized in a fairly static manner against a fairly static body of data. Where it is necessary to work on data ‘on the fly’, a typical solution is a moving window over recent past history. More recent work has also permitted computation of a running estimate of all these basic statistical values.

Accordingly, a need exists for analysis techniques that can applied to not only static and running window data sets, but also on running estimates.

### SUMMARY OF THE INVENTION

The present invention addresses the above-mentioned problems, as well as others, by providing a system and method of applying a function to a difference between a previous statistical summary and a current data value. In a first aspect, the invention provides a system for processing a set E of data event values Eᵢ, comprising: a system for selecting a function F(D); a system for estimating a value of X such that the sum of F(X−Eᵢ) for all data event values Eᵢ in the set E is zero, wherein the value X provides a general statistical property of the set of data event values E; and an analysis system for analyzing the general statistical property.

In a second aspect, the invention provides computer program product stored on a computer readable medium, which when executed, processes a set E of data event values Eᵢ, the computer program product comprising: program code configured for estimating a value of X for a function F such that the sum of F(X−Eᵢ) for all data event values Eᵢ in the set E is zero, wherein the value X provides a general statistical property of the set of data event values E; and program code configured for analyzing the general statistical property.

In a third aspect, the invention provides a method of processing data events, comprising: determining a difference between a statistical summary and a new data event value; inputting the difference into a selected function and generating an output; adding the previous statistical summary to the output of the selected function to obtain a new statistical summary; and analyzing the new statistical summary.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a data event processing system in accordance with an embodiment of the present invention.

FIG. 2 depicts a graph showing mean and median generation functions in accordance with an embodiment of the present invention.

FIGS. 3-4 depict graphs showing methods of dealing with outliers in accordance with an embodiment of the present invention.

FIGS. 5-8 depict graphs showing hybrid functions in accordance with an embodiment of the present invention.

FIGS. 9-10 depict graphs showing biased functions in accordance with an embodiment of the present invention.

### DETAILED DESCRIPTION OF THE INVENTION

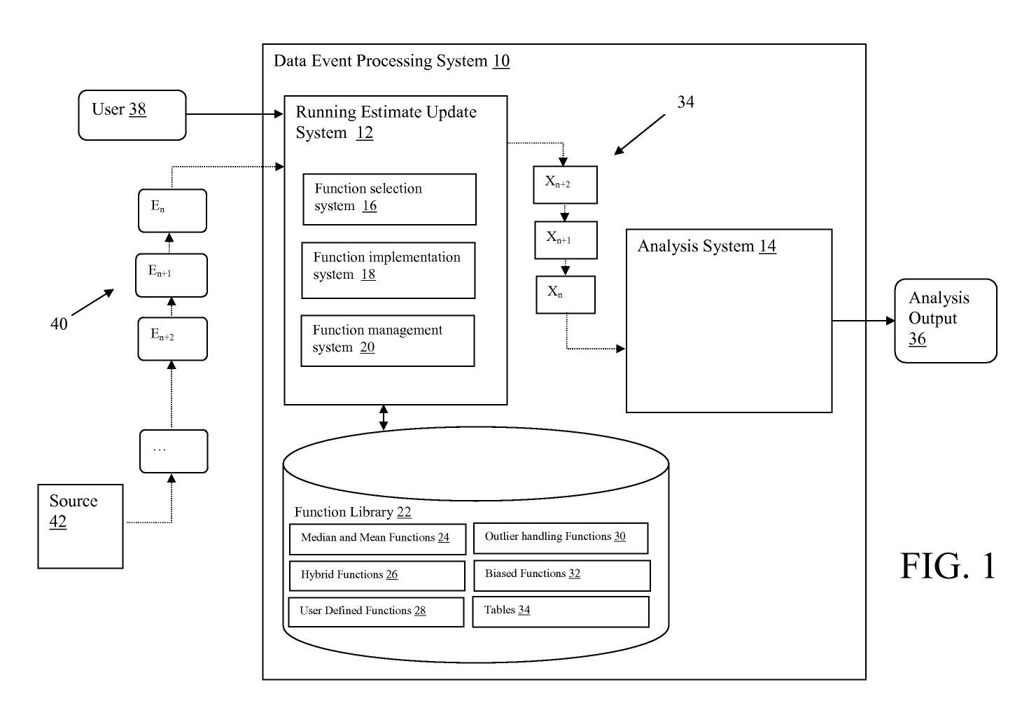

Disclosed are techniques for processing data events. In the illustrative embodiments discussed with regard to FIG. 1, a data event processing system 10 calculates/updates a statistical summary every time a new data event value is obtained, thereby providing a running estimate that allows for real time or near real time (i.e., dynamic) analysis. However, it should be understood that the techniques described herein are not limited to applications that generate running estimates, e.g., the generation of a statistical summary as described herein could be generated from static data sets, running windows, etc. Embodiments of the invention that are more suitable to static datasets are discussed below. Note that the static data embodiments may vary considerably in implementation detail from the running estimate embodiment shown in FIG. 1.

In FIG. 1, data event processing system 10 receives and processes a stream of data events 40 from a source 42 to create a statistical summary (i.e., “running estimate”) that can be analyzed by analysis system 14. In some instances, data events 40 will comprise numeric values, e.g., withdrawal amounts, bit usage, etc., whereas in other instances, data events 40 may simply comprise a binary value resulting from an occurrence or non-occurrence, e.g., a login, a withdrawal, etc. For the purposes of this disclosure, the term “running estimate” may refer to any type of running statistical summary that can be updated and captured in a single value (or set of values).

Accordingly, in the illustrative embodiment shown in FIG. 1, processing of data events 40 includes: (1) providing a running estimate update system 12 to update a running estimate Xᵢ each time a new data event Eᵢ is obtained; and (2) providing an analysis system 14 to analyze the running estimate Xᵢ after the estimate is updated. New running estimates are calculated based on a function F, e.g., selected from function library 22. More specifically, running estimate update system 12: (1) determines a difference D between a previous running estimate and a current event data value; (2) applies a selected function F to the difference D; and (3) adds the result to the previous running estimate to obtain the new running estimate.

Analysis system 14 provides mechanisms (e.g., algorithms, programs, heuristics, modeling, etc.) for examining each running estimate Xᵢ and providing some analysis, e.g., identifying potentially fraudulent activities, identifying trends and patterns, identifying risks, problems, opportunities, etc. For example, a high running estimate 34 may indicate an unusually large withdrawal from an ATM, an unusual amount of bandwidth usage in a network, etc. In a simple application, analysis system 14 might compare the running estimate to a threshold value. If the running estimate is above (or below) the threshold value, analysis system 14 may issue a warning as the analysis output 36.

Because the running estimate 34 can be captured in a single value, few computational resources are required, thus allowing real or near real time processing. Accordingly, data event processing system 10 allows for an immediate action or response to be made to unusual or potentially problematic data event values, without the need to process large amounts of data.

In this illustrative embodiment, running estimate update system 12 includes: a function selection system 16 for allowing a user 38 to select a function F from the function library 22; a function implementation system 18 for implementing the selected function F to a selected event data stream 40; and a function management system 20 for allowing user 38 to create, modify, and delete functions from function library 22.

Illustrative types of functions stored in function library 22 may include, e.g., median and mean generation functions 24, hybrid functions 26, user defined functions 28, outlier handling functions 30; biased functions 32; and tables 34. The functions described herein are not intended to be limiting to the scope of the invention, and other types of functions not described herein fall within the scope of the invention.

As noted above, running estimate update system 12 first calculates a difference D between a previously calculated running estimate Xₙ₋₁ and a current data event value Eₙ. The difference D is then plugged into a selected function F, the result of which is then used to modify (e.g., added to or subtracted from) the previous running estimate Xₙ₋₁ to generate a new running estimate Xₙ. Thus, in such an embodiment, a new running estimate Xₙ is calculated according to the general form:

Xₙ=Xₙ₋₁+(1−k)*F(Eₙ−Xₙ₋₁).

where k is a damping factor. In implementation, the factor (1−k) may be combined into a scaled function F. Keeping them uncombined separates the damping effect of the running computation from the behavioral effect of a particular function F.

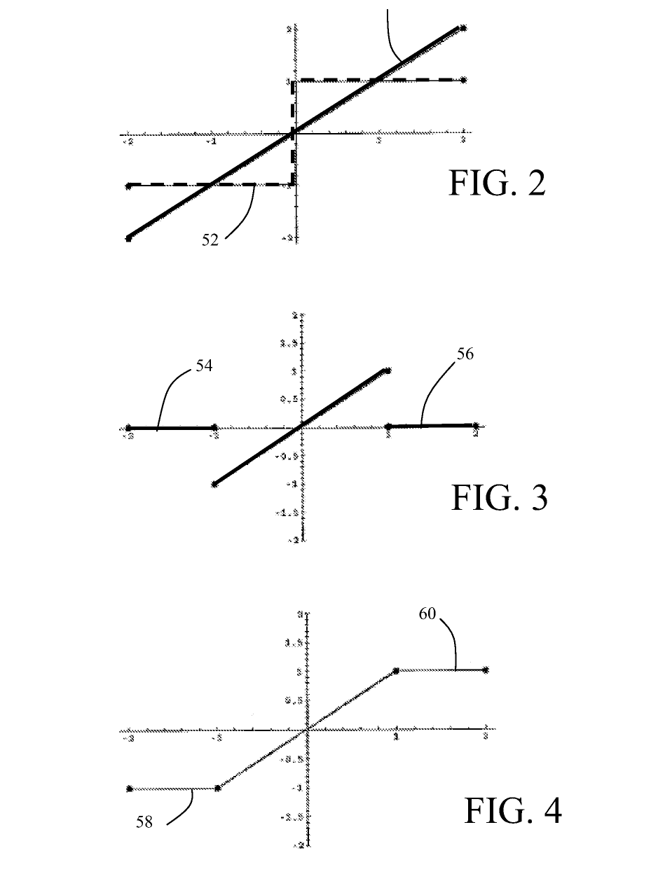

Illustrative functions are described below as graphs shown in FIGS. 2-10, where the difference D is represented as input along the X axis, and the result to be added to the previous running estimate is represented along the Y axis.

FIG. 2 depicts a graph of an example showing the functions 50, 52 used to generate a running mean and a running median respectively, where the functions are defined as follows:
Mean: F=D
Median: F=sign(D)
   In the case of the mean generation function 50, the function F simply uses the difference D to modify the previous running estimate. For instance, if the previous running estimate was 29, the new data event value was 27, and the damping factor k was 0.9, a difference D of −2 would be scaled by (1−0.9)=0.1 to give −0.2, then added to the previous running estimate to generate a new running estimate of 28.8. It will be observed that where the function F is the identity function, the equation above becomes

Xₙ=Xₙ₋₁+(1−k)*(Eₙ−Xₙ₋₁)=k*Xₙ₋₁+(1−k)*Eₙ

which is the conventional function for exponential smoothing.

In the case of the median generation function 52, the result of function F is either +1 or −1, depending on whether the difference D is positive or negative, and 0 for D=0. Thus, in the above example, a difference D of −2 would result in a −1 being added to the previous running estimate of 29, resulting in a new running estimate value of 28.

FIG. 3 depicts a modified mean generation function in which outlier regions 54 and 56 are eliminated. In this case, F=D, if D is in the range [−1 . . . 1] and F=0, otherwise. FIG. 4 depicts a further modified mean generation function in which outlier regions 58 and 60 are “flattened.” In this case, F=D, if D is in the range [−1 . . . 1], F=−1 if D<−1, and F=1 if D>1. Note that outlier handling may be implemented using any technique, e.g., it could be implemented directly in the function as above, via a software routine that can be applied to an existing function, etc.

General principles of the mean and median generation functions include:
1. The function F should avoid step functions. Step functions will give irregular behavior in mathematical analyses, especially optimizations. The step in the median generation function illustrates why median can give unstable results.
2. The function F should be negative for negative inputs and positive for positive inputs.
3. The function should be 0 for input 0.
4. The function should be symmetric to compute ‘middle values, but may be skewed to compute ‘non-middle’ values (such as 10'th percentile).
5. In most cases, the function should be monotone increasing. However, this depends on the reason for the outliers. If outliers are generally correct readings, but so extreme that they should not distort the general statistics, the function should flatten as it reaches the outliers (FIG. 4). If outliers are erroneous readings, their function should map to 0 (FIG. 3).

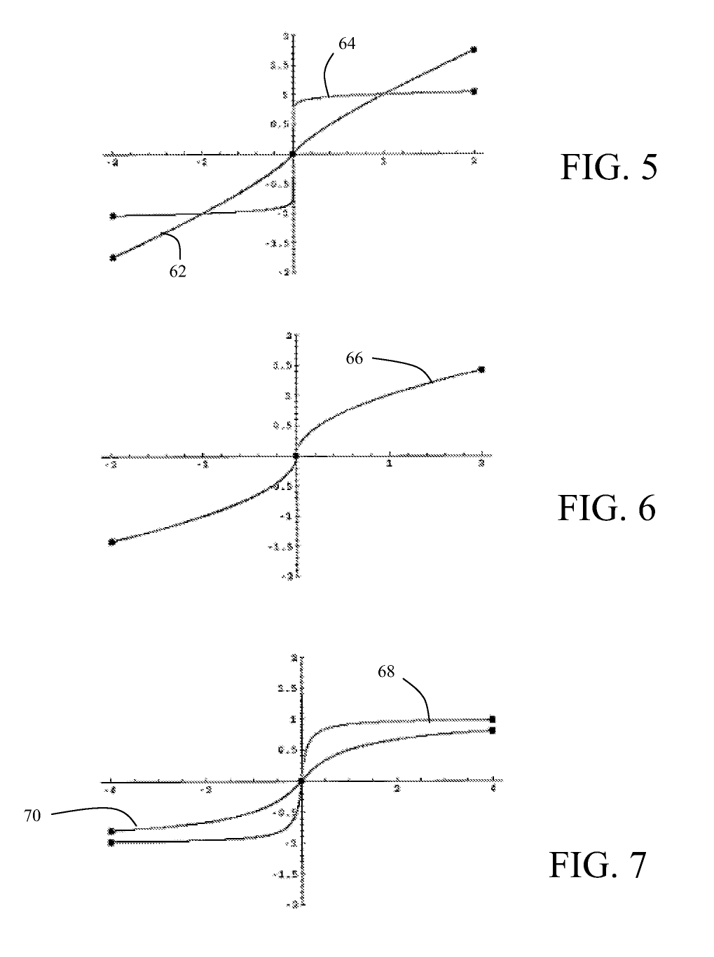

A second class of functions comprises hybrids of the mean and median generation functions. For example, FIG. 5 depicts a pair of “superegg” curves defined according to the function:

F=sign(D)*abs(D)^{Q}.

The superegg gives a range of functions between mean (Q=1) and median (Q=0). The graph in FIG. 5 demonstrates a first curve 62 with Q=0.85 (quite close to the straight line curve 50 for mean) and a second curve 64 with Q=0.05 (quite close to the step curve 52 for median). FIG. 6 depicts the superegg with Q=0.5 (i.e., a square root), which gives a compromise solution.

FIG. 7 depicts a second hybrid function referred to herein as an asymptotic median, defined by the function:

F=D/(Q−D), where D<=0

F=D/(Q+D), where D>0

Again, varying Q can force this function to look both like a median, and locally (for “small’ values of D) like a mean. In the example shown in FIG. 7, a first median-like curve 68 shows with the function with Q=0.1, and the second mean-like curve 70 shows the function with Q=1.

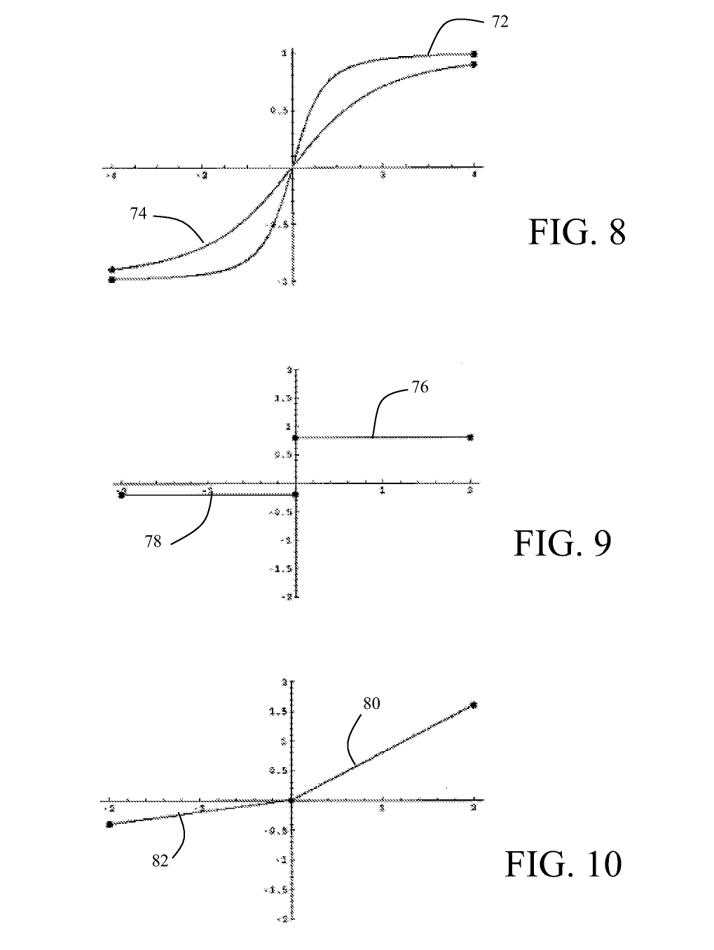

FIG. 8 depicts an alternative asymptotic median, defined by the function:

F=D/sqrt(D²+Q).

In this example, a first curve 72 shows with the function with Q=4, and the second curve 74 shows the function with Q=0.5.

A further class of functions involved biased functions in which the result is biased either in the positive or negative direction. For instance, FIG. 9 depicts a biased median (x^{th} percentile), defined by the function:

F=−Q, where D<0

F=1−Q, where D>0

F=0, where D=0.

In FIG. 9, Q=0.2, so that for a difference D less than 0, a first region 78 is defined where F=−0.2, and for a difference D greater than 0, a second region 76 is defined where F=0.8. A value of Q=0.5 give a median. In general Q gives the Q*100^{th} percentile.

FIG. 10 depicts a biased mean, defined by the function:

F=Q*D, where D<0

F=(1−Q)*D, where D>=0.

Again, a first region 82 is provided for cases where the difference D is less than 0, and a second region 80 is provided for cases where the difference D is greater than or equal to 0. Note that in general it may be desirable to have biased curves that do not have a discontinuity in the first derivative at 0.

The disclosed embodiments thus provide an enhanced approach for using mean and median. However, as noted above, the techniques described herein are not limited to “running estimate” applications, but can also apply to static data sets. Accordingly, the invention can be explained in a more comprehensive approach as follows. Consider all the data points Eᵢ as objects in one-dimensional space, with the mean or median to be computed as another center object X. The defined function F provides a force field F between each data object Eᵢ acting on this center object X. The combination of these force fields will pull the center object X to some stable center position. F is thus defined as a function F(D) of the (directional) distance D=Eᵢ−X.

The force field (i.e., function) F can therefore be tailored to give the required “center” effect by estimating a value of X such that the sum of F(Eᵢ−X) for all elements Eᵢ in the set E is zero. The resulting value X will thus provide a general statistical property of the set of values.

There are two generic implementations of this. For static data sets, standard iterative optimization techniques can be used. Of course, these may be very much optimized for particular functions. An example of an iterative approach for estimating X is provided below for the data set E₁ . . . E₆. An initial guess of 11.3 for X results in an initial sum of F(D) for the equation sign(Di)*abs(Di)^{0.5} to be 8.00171.

| X | X is target value | 11.3 initial ‘guess’ | | | | | |
|---|---|---|---|---|---|---|---|
| i | | 1 | 2 | 3 | 4 | 5 | 6 |
| E | Eᵢ is I'th value | 7 | 8 | 15 | 4 | 8 | 9 |
| D | Di = Eᵢ − X | −4.3 | −3.3 | 3.7 | −7.3 | −3.3 | −2.3 |
| F(D) | sign(Dᵢ) * abs(Dᵢ)^{0.5} | −2.07364 | −1.81659 | 1.923538 | −2.70185 | −1.81659 | −1.51658 |
| | sum(F(D)) | −8.00171 | | | | | |

### After a number of iterations, the sum eventually converges to zero, as shown below.

| X | X is target value | 8.07325 final result | | | | | |
|---|---|---|---|---|---|---|---|
| i | | 1 | 2 | 3 | 4 | 5 | 6 |
| E | Eᵢ is I'th value | 7 | 8 | 15 | 4 | 8 | 9 |
| D | Di = Eᵢ − X | −1.07325 | −0.07325 | 6.92675 | −4.07325 | −0.07325 | 0.92675 |
| F(D) | sign(Dᵢ) * abs(Dᵢ)^{0.5} | −1.03598 | −0.27065 | 2.631872 | −2.01823 | −0.27065 | 0.962679 |
| | sum(F(D)) | −0.00095 | | | | | |

### In this case, a final value for X that will yield a sum of 0.00095 is shown as 8.07325.

For dynamic datasets, techniques using a running estimate with the appropriate force field function can be used, as described in detail above with reference to the FIGS. 1-10. The computational requirements for the running estimate are quite modest, depending on the details of the function chosen.

Accordingly, in either case, a force field that is a compromise between a mean and median can be obtained. The exact function may be tailored for different requirements. The precise form of the function is not likely to have a great effect on overall results in a business application, with the differences being swamped by the effect of imprecise modeling and noisy data. It will generally be desirable to choose a function that has the correct general shape for the features required, and which can be efficiently implemented.

In general, data event processing system 10 may be implemented using any type of computing device, and may be implemented as part of a client and/or a server. Such a computing system generally includes a processor, input/output (I/O), memory, and a bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus provides a communication link between each of the components in the computing system and likewise may comprise any known type of transmission link, including electrical, optical, wireless, etc. Additional components, such as cache memory, communication systems, system software, etc., may be incorporated into the computing system.

Access to data event processing system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising a data event processing system 10 could be created, maintained and/or deployed by a service provider that offers the functions described herein for customers. That is, a service provider could offer to provide event processing as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for processing a set E of data event values Eᵢ, comprising:
a system for selecting a function F(D);
a system for estimating a value of X such that the sum of F(Eᵢ-X) for all data event values Eᵢ in the set E is approximately zero, wherein the value X provides a general statistical property of the set of data event values E; and
an analysis system for analyzing the general statistical property.

2. The system of claim 1, wherein the set E comprises a static data set, and the system for estimating a value of X uses a mathematical optimization technique.

3. The system of claim 2, wherein the mathematical optimization technique is selected from the group consisting of: a relaxation technique and an iterative approach.

4. The system of claim 1, wherein the set E includes a dynamic stream of data event values, and the system for estimating a value of X updates a running estimate each time a new data event is obtained, wherein a new running estimate is determined based on the selected function F(D) that operates on a difference of a previous running estimate and a new data event value.

5. The system of claim 4, wherein the new running estimate is calculated by adding an output of the selected function to the previous running estimate.

6. The system of claim 1, wherein the selected function F(D) comprises a hybrid of a mean generation function and a median generation function.

7. The system of claim 6, wherein the hybrid is selected from the group consisting of:
a superegg function and an asymptotic function.

8. The system of claim 1, wherein the selected function F(D) comprises a biased function.

9. The system of claim 1, wherein the selected function F(D) includes a technique for handling outliers.

10. The system of claim 1, wherein the selected function F(D) comprises a table or a user-defined function.

11. The system of claim 1, further comprising: a function implementation system for applying the selected function F(D) to the data event values Ei, and a function management system for allowing a user to create, modify and delete functions in a function library.

12. The system of claim 1, wherein the analysis system generates analysis output that includes information selected from the group consisting of: a warning; a potentially fraudulent activity; a high data event value; a low data event value; a deviation, a risk, and an opportunity.

13. A computer readable medium comprising a computer program product stored thereon, which when executed, processes a set E of data event values Eᵢ, the computer readable medium comprising:
program code configured for estimating a value of X for a function F such that the sum of F(Eᵢ-X) for all data event values Eᵢ in the set E is approximately zero, wherein the value X provides a general statistical property of the set of data event values E; and
program code configured for analyzing the general statistical property and outputting an analysis output.

14. The computer program product of claim 13, wherein the set E includes a dynamic stream of data event values, and the program code configured for estimating a value of X updates a running estimate each time a new data event is obtained, wherein a new running estimate is determined based on the function F that operates on a difference of a previous running estimate and a new data event value.

15. The computer program product of claim 13, wherein the function F is selected from the group consisting of a mean generation function, a median generation function, a hybrid of a mean generation function and a median generation function, and a biased function.

16. The computer program product of claim 13, wherein the function F is selected from the group consisting of: a superegg function and an asymptotic function.

17. The computer program product of claim 13, further comprising program code for modifying the function F to handle outliers.

18. The computer program product of claim 13, wherein the function F comprises a table or a user-defined function.

19. The computer program product of claim 14, further comprising program code configured for allowing a user to select the function F from a function library, for applying the selected function F to the dynamic stream of data event values, and for allowing a user to create, modify and delete functions in the function library.

20. The computer program product of claim 13, wherein the program code configured for analyzing the general statistical property generates analysis output that includes information selected from the group consisting of: a warning; a potentially fraudulent activity; a high data event value; a low data event value; a deviation, a risk, and an opportunity.

21. A method of processing data events, comprising:
determining a difference between a statistical summary and a new data event value;
inputting the difference into a selected function F and generating an output;
estimating a value of X for the selected function F such that the sum of F(Eᵢ-X) for all data event values Eᵢ in a set E is approximately zero;
adding the statistical summary to the output of the selected function F to obtain a new statistical summary; and
analyzing the new statistical summary.

22. The method of claim 21, wherein the selected function F is selected from the group consisting of a mean generation function, a median generation function, a hybrid of a mean generation function and a median generation function, and a biased function.

23. The method of claim 21, wherein the selected function F includes a technique for handling outliers.
